(19) United States
(12) Patent Application Publication
(10) Pub. No.: US 2007/0038851 A1
(43) Pub. Date: Feb. 15, 2007

(54) Method for programming secure data into integrated circuits

(76) Inventors: Amit Gordhanbhai Babaria, Grapevine, TX (US); Kevin Dale Bittick, Dallas, TX (US); Dennis Harold Burke JR., Allen, TX (US); Chen-Yi Shannon Su, Dallas, TX (US)

Correspondence Address: TEXAS INSTRUMENTS INCORPORATED, P O BOX 655474, M/S 3999, DALLAS, TX, 75265, US

(21) Appl. No.: 11/203,501

(22) Filed: Aug. 12, 2005

(51) Int. Cl. G06F 15/177

(52) U.S. Cl. 713/1

(57) ABSTRACT

A method for programming secure data into nonvolatile memory in an IC is disclosed. The method includes steps for loading the secure data into temporary memory, temporarily disabling tester logging functions, and loading the secure data from temporary memory to the nonvolatile memory of the device. Further steps include verifying that the secure data is correctly loaded into the nonvolatile memory of the IC and implementing protection for the programmed secure data to prevent access subsequent to programming. Aspects of the invention include the selection or modification of patterns for programming secure data into nonvolatile memory. Temporary memory containing secure data and/or modified patterns is erased. The programming and protecting steps take place within a single instruction to the TOS so that the user does not regain access to the IC until the secure data is protected within the IC.

### TECHNICAL FIELD

The invention relates to the manufacturing and testing of integrated circuitry. More particularly, the invention relates to methods for programming secure data into integrated circuits (ICs).

### BACKGROUND OF THE INVENTION

In the electronic arts concerned with the design, manufacture, and testing of integrated circuitry, it is known to include non-volatile memory cells in order to permanently store information within the circuitry. Reference data such as identification, configuration or encryption data, pertaining to the device may be stored. In some cases, it is desirable to store confidential data for use by the IC itself or related circuitry. For example, it may be desirable from a commercial standpoint for a manufacturer of semiconductor devices to prevent customers from accessing certain information stored on the devices. It may also be desirable to prevent access to secure data during certain stages of manufacture and testing, and even on discarded defective devices. Situations can arise, for example, when a customer requires certain secure data to be incorporated into permanent memory in an IC by the manufacturer. This requires the manufacturer to implement methods of protecting secure data during all stages manufacture such as preparation for testing, testing, and the discarding of defective devices. Such considerations present challenges in providing an embedded testing approach to programming secure data into ICs in such a way that the contents of the secure data is not compromised after successful programming, through intercession during manufacture and testing, or recovered from discarded defective devices. Due to these and other challenges, methods to ensure that secure data programmed into the IC is not made available outside of the Tester Operating System software during testing would be useful and advantageous in the arts.

### SUMMARY OF THE INVENTION

In carrying out the principles of the present invention, in accordance with preferred embodiments thereof, methods for programming secure data into permanent IC memory are disclosed for use within a Tester Operating System (TOS) while nevertheless remaining shielded from access at the Tester User Interface (TUI) associated with the TOS.

According to one aspect of the invention, a method for programming secure data into nonvolatile memory in an IC includes steps for loading the secure data into temporary memory, temporarily disabling tester logging functions, and loading the secure data from temporary memory to the nonvolatile memory of the device. Further steps include verifying that the secure data is correctly loaded into the nonvolatile memory of the IC and implementing protection for the programmed secure data to prevent access subsequent to programming.

According to another aspect of the invention, a method for programming secure data into nonvolatile memory in an IC may be embedded within a TOS for loading the secure data into temporary memory, selecting a programming template pattern and using the pattern to program secure data into nonvolatile memory. The correct loading of the secure data into the nonvolatile memory of the IC is verified, and the data is protected from later being read or overwritten. The method also includes steps for disabling tester logging functions for the duration of the programming steps.

According to another aspect of the invention, a method for programming secure data into nonvolatile memory in an IC is disclosed. The method includes steps for loading the secure data into temporary memory, selecting a programming template pattern, storing the selected pattern in volatile memory, and modifying the pattern stored in volatile memory for use in programming the secure data. In further steps, using the modified pattern, the secure data is loaded into the nonvolatile memory of the IC, verified for accuracy, and protected from future access. The tester logging functions are disabled during the programming process to ensure that the secure data remains inaccessible. Temporary memory containing secure data and/or modified patterns is erased.

The invention has advantages including but not limited to providing methods for programming ICs with secure data while maintaining a high level of protection for the secure data during and after programming. These and other features, advantages, and benefits of the present invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the following detailed description and drawings in which:

FIG. 1 is a process flow diagram showing an overview of the methods of programming permanent IC memory with secure data according to the invention;

FIG. 2 is a process flow diagram illustrating an example of a method for programming secure data using selected patterns according to a preferred embodiment of the invention;

FIG. 3 is a process flow diagram illustrating an example of a method for programming secure data using temporarily modified patterns according to a preferred embodiment of the invention; and

FIG. 4 is a process flow diagram illustrating an example of a method for programming secure data according to an example of a preferred embodiment of the invention including selectable alternative pattern handling steps.

References in the detailed description correspond to like references in the various drawings unless otherwise noted. Drawings depicting steps in methodologies are necessarily conceptual in nature and are presented for describing the essentials of the invention. The drawings are not intended to be interpreted in a physically limiting sense as literally describing every possible alternative embodiment of the invention in every detail. Descriptive and directional terms used in the written description such as first, second, top, bottom, etc., refer to the drawings themselves as laid out on the paper and not to physical limitations of the invention unless specifically noted. The drawings are not to scale, and some features of embodiments shown and discussed are simplified or amplified for illustrating the principles, features, and advantages of the invention.

### DETAILED DESCRIPTION OF PREFERRED EMBODIMENTS

In general, the invention provides methods for programming secure data into an IC during the testing of the IC in such a way that ensures that the data will not be compromised during or after programming or by logs kept by the programming process itself. The term, “secure data” is used to refer to confidential data to which it is desired to restrict access. An example of secure data encountered in the semiconductor device manufacturing field is customer-supplied confidential information provided to the manufacturer for inclusion in the customer's ICs. This is but one example providing a convenient context for describing the invention and is not intended to limit the application of the invention. To cite another example, the secure data may originate with the manufacturer of an IC provided for general use to a customer. Using the invention, the Tester Operating System (TOS) isolates the handling of the secure data during programming. This restricts the access to the secure data so that only the TOS, and not for example the user of the TOS, has access to that data. The invention also includes steps encompassing the operations required by the particular IC being programmed to ensure that the secure data is read- and/or write-protected before the software using the TOS regains access/control of the IC.

The processing required within the methodology of the invention varies with the type of IC with which the invention is practiced. Different types of IC's may permanently “store” the secure data in different ways, for example, e-fuse, EPROM, etc., and the techniques used by the TOS to program the IC's may vary due to these differences, but the methodology of the invention remains the same. Such adaptation is within the capabilities of those reasonably skilled in the arts without extensive experimentation based on the description outlined herein. The inputs, outputs and power supplies of the IC must be manipulated by the TOS multiple times in order to program the secure data into the IC, to verify the correct programming of the secure data into the IC and to read- and/or write-protect the secure data within the permanent memory of the IC. Throughout this processing, the TOS must ensure that the secure data is not compromised.

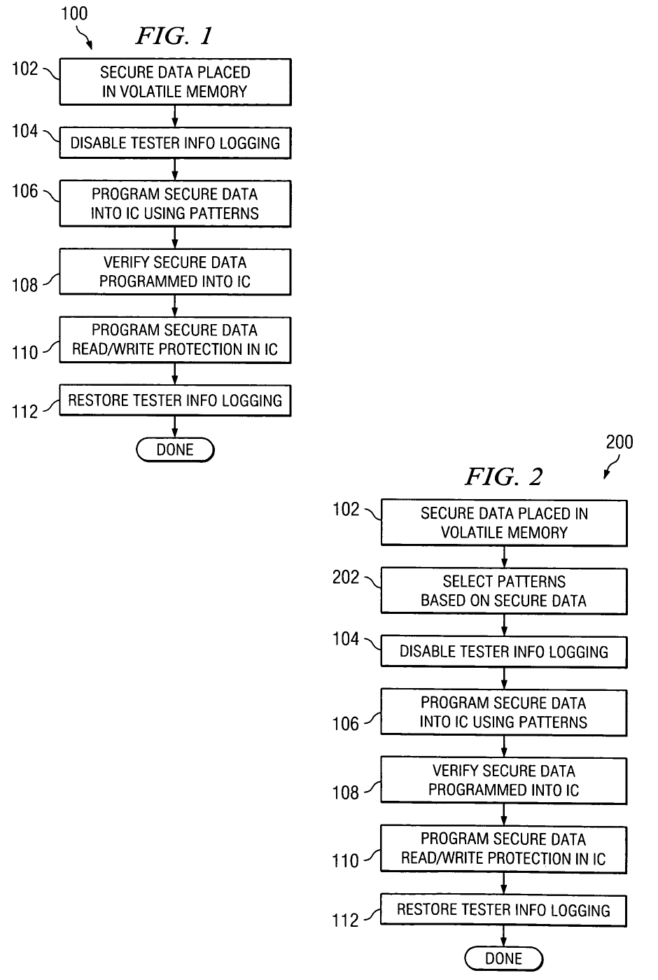

Overviews of the programming and the protection process flow of the invention are shown and described with reference to the figures included herein. Referring in general to the drawings, FIG. 1 depicts a general view of the steps common to the preferred embodiments of the invention, and FIGS. 2 though 4 depict alternatives and combinations within the scope of FIG. 1. The steps for programming the secure data into the IC, verifying the successful programming of the secure data into the IC, and read/write-protecting the secure data within the IC, all require that the inputs, outputs, and supplies of the IC be manipulated. These steps require that a significant amount of information which defines the interface to the IC be available to the TOS in order to accomplish them. This is general information regarding the IC, not secure data. While it is an implicit requirement that this IC information be available to the TOS at the time that the TOS is accessed to accomplish these steps, there is no specific requirement as to how this data is to be made available. There are various alternative ways that this IC-specific information could be made available to the TOS.

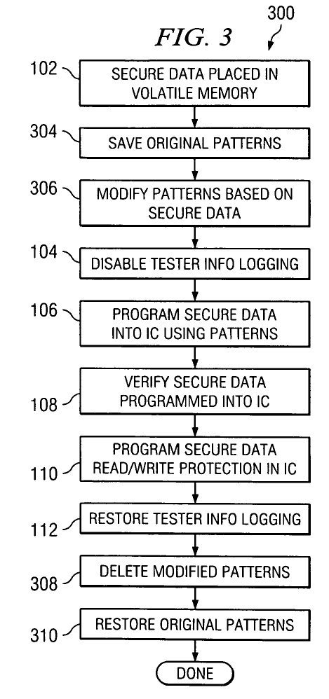

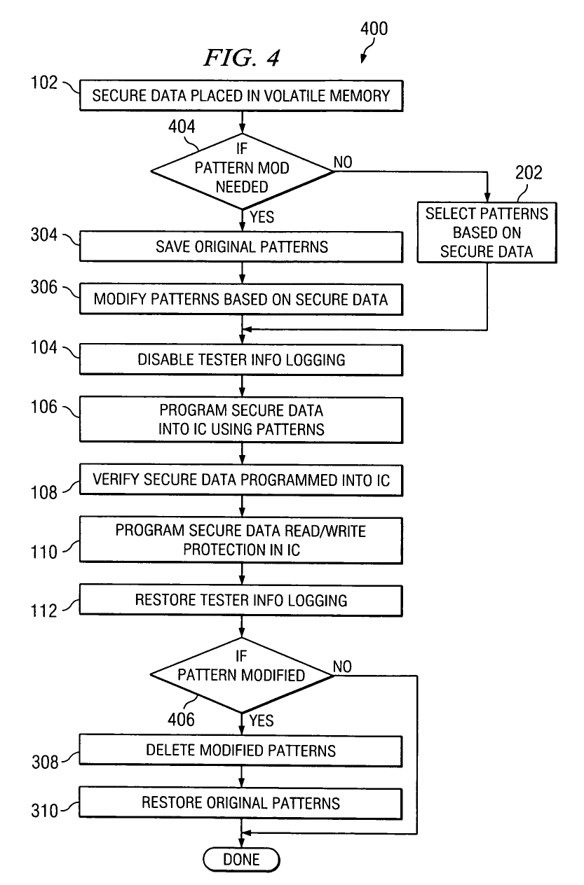

There are presently two alternative preferred approaches within the methodology of the invention for the actual programming of the IC's. One approach, further discussed with reference to FIG. 2, uses a sequence of predefined patterns based upon the secure data to be programmed into the IC. The terms “template pattern” or “pattern” reference a set of information, e.g., data and/or instructions concerning how to program the secure data into the particular IC. The other approach, further discussed with reference to FIG. 3, includes steps for modifying predefined patterns based on the secure data to be programmed into the IC. In either case, the invention ensures that the logging of tester information is disabled prior to transferring the patterns to the IC, and during the programming of secure data into it, during the verification of the programming of the secure data, and during the application of measures to protect the programmed secure data. FIG. 4 illustrates an alternative embodiment of the invention including the potential for selecting from the combination of the techniques described with reference to FIGS. 2 and 3 according to the nature of the device under test.

Referring primarily to FIG. 1, an overview of the process flow 100 of methods of the invention is shown. It is assumed for the sake of providing a starting point for the disclosure that the secure data is provided to the Tester Operating System (TOS). The manner of accomplishing this transfer, and steps in developing the secure data are not essential to the practice of the invention. Processes and tools available from Texas Instruments Incorporated may be used, for example. As shown at box 102, the secure data is copied to temporary memory made available to the TOS. It should be appreciated that the secure data is not made accessible, e.g. for display, print, storage, outside of the TOS. This precaution ensures that the secure data is not compromised. The tester information logging function is disabled by the TOS 104. The operational details of the test logging functions and of particular tester functionality are not essential as long as logging is discontinued so that the secure data cannot be recovered from the tester after programming. During the period of discontinuation of tester logging, the secure data is programmed into the permanent memory of the IC 106. Preferably, the programming step 106 is accompanied by a verification step 108, to ensure that the secure data is correctly programmed into the nonvolatile memory of the IC. It should be understood that the verification of the secure data at this stage is particularly important, as the secure data will be made inaccessible after programming is completed. There are additional steps that may be implemented in various alternative embodiments of the invention in the event that the successful programming of the secure data cannot be verified. For example, depending upon the type of IC memory and programming techniques used, the programming efforts may be reattempted, the data may be rewritten, or the programming abandoned. As shown at step 110, the programmed secure data is protected. The scope of protection preferably includes read-protection and write-protection according the capabilities of the particular memory cells implemented in the IC. The protection of step 110 ensures that the secure data is not altered or accessed after programming. Following the protection 110 of the secure data programmed to the nonvolatile memory of the IC, the tester information logging is restored 112. Accordingly, the tester may be used to perform additional tasks common in the tester arts, such as further testing, programming, or other common operations. However the secure data programmed during the interval that the TOS, and not the tester user interface (TUI), controlled the programming is inaccessible, and the lack of logged information makes it very difficult to retrace the programming steps in an effort to recover the content of the secure data.

Now referring primarily to FIG. 2, according to a variation in the process flow 200, when the IC programming method being utilized requires a sequence of predefined patterns based on the secure data to be programmed, the TOS may be used to determine the patterns required and the sequence in which they are to be used 202 with secure data placed in temporary memory 102. As long as the pattern sequence used is not accessible to the user of the TOS the secure data will not be compromised. Once tester information logging has been disabled 104, the TOS programs the secure data into the IC using the patterns that correspond to the secure data 106. After the secure data is programmed into the IC, the TOS queries the IC to ensure that the secure data was programmed successfully 108. The process performed by the TOS in the event that the secure data was not programmed successfully is dependent upon the type of IC being programmed. This information is specific to particular IC types, for example in some ICs programming may be abandoned if unsuccessful at this point, in other ICs, alternative memory blocks may be reserved for reprogramming attempts. Various approaches are possible without departure form the invention. The verification must be performed by the TOS to ensure that the secure data is not compromised. The user of the TOS would otherwise require access to the secure data in order to perform the verification outside of the TOS. After verification of the accurate programming of the secure data into the IC 108, the necessary processing is performed for the particular type of IC being programmed to ensure that the secure data within the IC is read- and/or write-protected 110. It should be noted that the programming of the read-/write-protection within the IC must be performed by the TOS to ensure that the secure data is not compromised. If the TOS were to return control to the user prior to protecting the secure data programmed into the IC, then the user of the TOS would be able to write invalid data into the IC, or read the valid secure data out of the IC, or both. Once all of the patterns that correspond to the secure data programmed into the IC have been transferred to the IC, the tester information logging is restored back to its original state 112.

In some applications, the IC programming method utilized requires template patterns to be modified based on the secure data to be programmed. As depicted in the process flow 300 of FIG. 3, after the secure data is loaded into temporary memory 102, the original template pattern is saved 304. Temporary copies of the patterns are made and modified according to the secured data 306. The logging functions of the tester are disabled 104, programming 106, verification 108 and protection 110 steps proceed as described. When these steps are completed, the logging functions are restored 112 and the temporary copies of the patterns containing the changes dependent upon the secure data are destroyed 308. The saved, original copies of the template patterns are then restored 310. This ensures that the secure data is not compromised when the user of the TOS is given access to the template patterns when control is returned to the user.

FIG. 4 provides an additional overview of an embodiment of the invention which offers a selection among alternative steps of the invention previously described. As shown at decision box 404, after the secure data is placed in temporary memory, step 102, a selection may be made as to whether the particular iteration of the invention will use selected template patterns 202 or tester-modified patterns, steps 304, 306. Regardless of which alternative is used, as described, tester logging is disabled 104, secure data is programmed into permanent IC memory using the appropriate patterns 106, and the programmed secure data is verified 108, and protected 110 prior to the restoration of tester logging 112. In the event that modified patterns have been used, as shown in decision diamond 406, the modified patterns stored in temporary memory are destroyed 308 and the original patterns are restored 310. It should be recognized by those skilled in the arts that the steps of deleting the modified patterns 308 and restoring the original patterns 310 may alternatively be performed prior to restoration of the tester logging functions 112 without departure from the invention.

The methods and systems of the invention provide advantages including but not limited to providing methods for programming ICs with secure data without compromising the secure data. The data is shielded from access by a user of the TOS programming the secure data to the IC, and from attempts to read the secure data from the programmed IC itself. While the invention has been described with reference to certain illustrative embodiments, the methods and systems described are not intended to be construed in a limiting sense. Various modifications and combinations of the illustrative embodiments as well as other advantages and embodiments of the invention will be apparent to persons skilled in the arts upon reference to the drawings, description, and claims.

We claim:

1. In a Tester Operating System (TOS), a method for programming secure data into nonvolatile memory in an IC, comprising the steps of:
loading the secure data into temporary memory;
disabling logging functions of the TOS;
loading the secure data from temporary memory to the nonvolatile memory of the IC;
verifying the secure data loaded into the nonvolatile memory of the IC;
implementing protection of the data loaded into the nonvolatile memory of the IC; and
restoring logging functions.

2. A method according to claim 1 wherein the steps are performed in a single instruction to the TOS whereby all loading, verification and protection of the secure data into the nonvolatile memory of the IC remains inaccessible to the user of the TOS.

3. A method according to claim 1 further comprising the step of deleting the secure data from volatile memory.

4. A method according to claim 1 wherein the step of verifying the secure data further comprises the step of comparing the secure data loaded into nonvolatile memory to the secure data stored in volatile memory, and thereafter reiterating the loading step.

5. A method according to claim 1 wherein the protection step further comprises implementing permanent read-protection for the nonvolatile memory containing the secure data.

6. A method according to claim 1 wherein the protection step further comprises implementing permanent write-protection for the nonvolatile memory containing the secure data.

7. A method according to claim 1 further comprising the step of selecting a pattern adapted for use in programming the secure data.

8. A method according to claim 1 further comprising the steps of:
selecting a programming pattern;
storing the pattern in volatile memory;
modifying the pattern stored in volatile memory for use in programming the secure data;
using the modified pattern to program secure data into nonvolatile memory; and
deleting the pattern stored in volatile memory.

9. In a Tester Operating System (TOS), a method for programming secure data into nonvolatile memory in an IC, comprising the steps of:
loading the secure data into temporary memory;
selecting a pattern within the TOS;
using the selected pattern to program secure data into nonvolatile memory;
disabling TOS logging functions;
loading the secure data from temporary memory to the nonvolatile memory of the IC;
verifying the secure data loaded into the nonvolatile memory of the IC;
implementing protection of the data loaded into the nonvolatile memory of the IC; and
restoring logging functions of the TOS.

10. A method according to claim 9 wherein the steps are performed in a single instruction to the TOS whereby all loading, verification and protection of the secure data into the nonvolatile memory of the IC remains inaccessible to the user of the TOS.

11. A method according to claim 9 further comprising the step of deleting the secure data from volatile memory.

12. A method according to claim 9 wherein the step of verifying the secure data further comprises the step of comparing the secure data loaded into nonvolatile memory to the secure data stored in volatile memory, and thereafter reiterating the loading step.

13. A method according to claim 9 wherein the protection step further comprises implementing permanent read-protection for the nonvolatile memory containing the secure data.

14. A method according to claim 9 wherein the protection step further comprises implementing permanent write-protection for the nonvolatile memory containing the secure data.

15. In a Tester Operating System (TOS), a method for programming secure data into nonvolatile memory in an IC, comprising the steps of:
loading the secure data into temporary memory;
selecting a programming pattern;
storing the pattern in volatile memory;
modifying the pattern stored in volatile memory for use in programming the secure data;
disabling TOS logging functions;
using the modified pattern, loading the secure data from temporary memory to the nonvolatile memory of the IC;
verifying the secure data loaded into the nonvolatile memory of the IC;
implementing protection of the data loaded into the nonvolatile memory of the IC;
deleting the pattern stored in volatile memory; and
restoring logging functions of the TOS.

16. A method according to claim 15 wherein the steps are performed in a single instruction to the TOS whereby all loading, verification and protection of the secure data into the nonvolatile memory of the IC remains inaccessible to the user of the TOS.

17. A method according to claim 15 further comprising the step of deleting the secure data from volatile memory.

18. A method according to claim 15 wherein the step of verifying the secure data further comprises the step of comparing the secure data loaded into nonvolatile memory to the secure data stored in volatile memory, and thereafter reiterating the loading step.

19. A method according to claim 15 wherein the protection step further comprises implementing permanent read-protection for the nonvolatile memory containing the secure data.

20. A method according to claim 15 wherein the protection step further comprises implementing permanent write-protection for the nonvolatile memory containing the secure data.
